(19) United States
(12) Patent Application Publication
(10) Pub. No.: US 2013/0194391 A1
(43) Pub. Date: Aug. 1, 2013

(54) STEREOSCOPIC CAMERA

(71) Applicant: C. Alexander Morrow, Gahanna, OH (US)

(72) Inventor: C. Alexander Morrow, Gahanna, OH (US)

(73) Assignee: BATTELLE MEMORIAL INSTITUTE, Columbus, OH (US)

(21) Appl. No.: 13/878,034

(22) PCT Filed: Oct. 5, 2011
(86) PCT No.: PCT/US11/54866

§ 371 Date: Apr. 5, 2013

Related U.S. Application Data
(60) Provisional application No. 61/390,293, filed on Oct. 6, 2010.

(51) Int. Cl. H04N 13/02

(52) U.S. Cl. CPC H04N 13/0203
USPC 348/49

(57) ABSTRACT

A stereoscopic camera is provided comprising: an image sensor; a lens system adapted to focus light from a scene onto the image sensor, the lens system including an aperture stop; an electronically actuatable matrix shutter including a plurality of individually addressable and actuatable shutter elements; a memory; and a processor communicating with the electronically actuatable matrix shutter and the memory. The processor may control the matrix shutter to create pairs of pupil apertures according to a plurality of exposure patterns stored in the memory.

### TECHNICAL FIELD

The present invention is directed to a stereoscopic camera having an electronically actuatable matrix shutter.

### BACKGROUND ART

U.S. Pat. No. 7,106,377 discloses a still image capturing device including an image sensor comprising a plurality of pixel elements and an electronically actuatable shutter device including a plurality of individually addressable and actuatable shutter elements. The shutter device may be formed or assembled to the image sensor such that the shutter device is controlled to expose small regions or individual pixel elements of the image sensor.

U.S. Pat. No. 6,275,335 discloses an aperture stop positioned within a lens system, see FIG. 2A in the '335 patent.

### DISCLOSURE OF INVENTION

In accordance with a first aspect of the present invention, a stereoscopic camera is provided comprising: an image sensor; a lens system adapted to focus light from a scene onto the image sensor, the lens system including an aperture stop; an electronically actuatable matrix shutter including a plurality of individually addressable and actuatable shutter elements; a memory; and a processor communicating with the electronically actuatable matrix shutter and the memory. The processor may control the matrix shutter to create pairs of pupil apertures according to a plurality of exposure patterns stored in the memory. The memory may store a first exposure pattern defining a first pair of first and second pupil apertures spaced apart from one another by a first distance and a second exposure pattern defining a second pair of third and fourth pupil apertures spaced apart from one another by a second distance which is different from the first distance.

The first, second, third and fourth pupil apertures may be of generally the same size.

The first and second pupil apertures may be sized differently from the third and fourth pupil apertures such that a first depth of field corresponding to the first exposure pattern differs from a second depth of field corresponding to the second exposure pattern.

The first pupil aperture may be defined by a first set of shutter elements that are light transmissive for a first predefined period of time and the second pupil aperture is defined by a second set of shutter elements that are light transmissive for a second predefined period of time.

The first and second pupil apertures may be sequentially formed by the matrix shutter.

The matrix shutter may comprise a liquid crystal shutter element comprising a two-dimensional array of individually addressable and actuatable shutter elements.

The matrix shutter may be positioned generally at the aperture stop.

In accordance with a second aspect of the present invention, a stereoscopic camera is provided comprising: an image sensor; a lens system adapted to focus light from a scene onto the image sensor, the lens system including an aperture stop; an electronically actuatable matrix shutter including a plurality of individually addressable and actuatable shutter elements; a memory; and a processor communicating with the electronically actuatable matrix shutter and the memory. The processor may control the matrix shutter to create pairs of pupil apertures according to a plurality of exposure patterns stored in the memory. The memory may store a first exposure pattern defining a first pair of first and second pupil apertures, each of a first size, and a second exposure pattern having a second pair of third and fourth pupil apertures, each of a second size, which is different from the first size such that a first depth of field corresponding to the first exposure pattern differs from a second depth of field corresponding to the second exposure pattern.

Center points of the first and second pupil apertures may be separated from one another by a first distance and center points of the third and fourth pupil apertures may be separated from one another by a second distance which is generally equal to the first distance.

The first pupil aperture may be defined by a first set of shutter elements that are light transmissive for a first predefined period of time and the second pupil aperture may be defined by a second set of shutter elements that are light transmissive for a second predefined period of time.

The first and second pupil apertures may be sequentially formed by the matrix shutter.

The matrix shutter may comprise a liquid crystal shutter element comprising a two-dimensional array of individually addressable and actuatable shutter elements.

The matrix shutter may be positioned generally at the aperture stop.

### BRIEF DESCRIPTION OF DRAWINGS

FIG. 1 is a schematic view of a stereoscopic camera constructed in accordance with the present invention;

FIG. 1A is a schematic perspective view a matrix shutter comprising a two-dimensional array of individually addressable and actuatable shutter elements;

FIG. 2 illustrates the camera taking a still image or video of a scene O₂;

FIG. 3 is a view of the matrix shutter controlled in accordance with a first exposure pattern;

FIG. 3A is a view illustrating a first left perspective image of the scene provided to an image sensor when a first pupil aperture is light transmissive and a first right perspective image of the scene is provided to the image sensor when a second pupil aperture is light transmissive;

FIG. 4 is a view of the matrix shutter controlled in accordance with a second exposure pattern;

FIG. 4A is a view illustrating a second left perspective image of the scene provided to an image sensor when a third pupil aperture is light transmissive and a second right perspective image of the scene is provided to the image sensor when a fourth pupil aperture is light transmissive;

FIG. 5 is a view of the matrix shutter controlled in accordance with a third exposure pattern;

FIG. 5A is a view illustrating a third left perspective image of the scene provided to an image sensor when a fifth pupil aperture is light transmissive and a third right perspective image of the scene is provided to the image sensor when a sixth pupil aperture is light transmissive;

FIG. 6 is a view of the matrix shutter controlled in accordance with a fourth exposure pattern; and

FIG. 6A is a view illustrating a fourth left perspective image of the scene provided to an image sensor when a seventh pupil aperture is light transmissive and a fourth right perspective image of the scene is provided to the image sensor when a eighth pupil aperture is light transmissive.

### MODES FOR CARRYING OUT THE INVENTION

In accordance with the present invention, a stereoscopic camera 10 capable of generating a 3-dimensional (3-D) still image or video images is provided comprising a housing 12, an image sensor 14, a lens system 20, an electronically actuatable matrix shutter 30, memory M and a processor P. The processor P is coupled to the matrix shutter 30 and the memory M and may be coupled to the image sensor 14 if it is electronic.

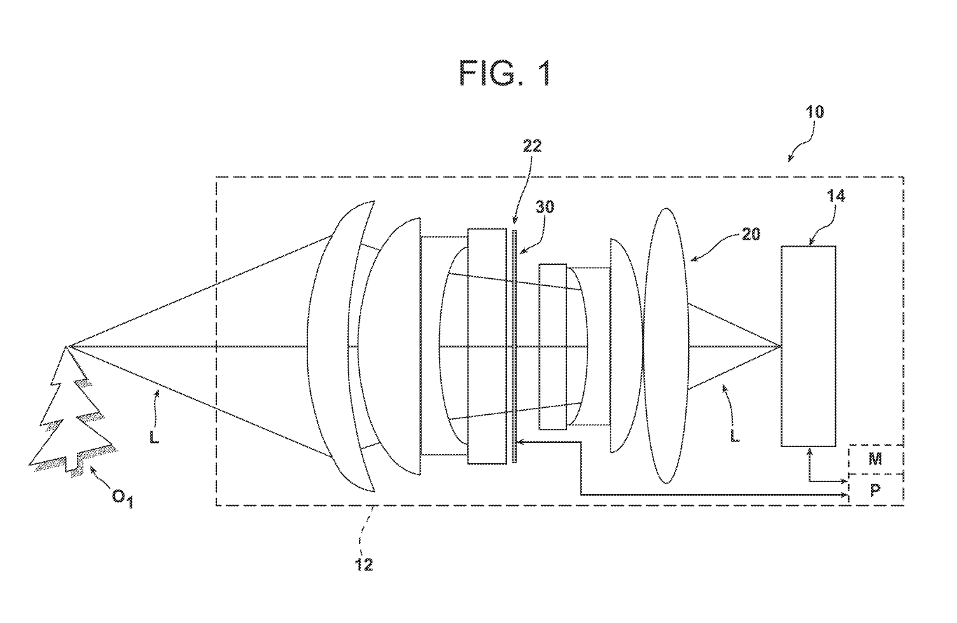

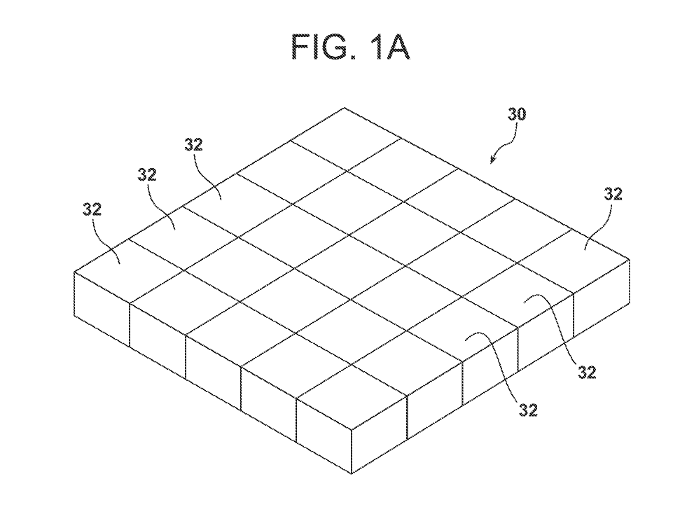

The electronically actuatable matrix shutter 30 comprises, in the illustrated embodiment, a liquid crystal element comprising a two-dimensional array of individually addressable and actuatable shutter elements 32, see FIGS. 1 and 1A. The matrix shutter 30 is preferably located at an aperture stop or aperture plane 22, which, in the illustrated embodiment, is defined within the lens system 20, see FIG. 1. The matrix shutter 30 is preferably located at the aperture stop 22, which is disposed across the entire cross section of the optical path extending through the camera 10. It is contemplated that the matrix shutter 30 may be placed forward or behind the aperture plane 22, which placement of the matrix shutter 30 may cause vignetting of outer edges of the image. As will be discussed further below, the processor P actuates one or more of the shutter elements 32 in accordance with a desired exposure pattern stored in the memory M so as to allow light L from an image or scene O₁ to pass through the shutter 30 and impinge on the image sensor 14, see FIG. 1.

Light L from the object or scene O₁ also passes through the lens system 20, which focuses the light, i.e., the light rays, onto the image sensor 14, see FIG. 1.

In the illustrated embodiment, the image sensor 14 may comprise an electronic image sensor such as a charged-coupled device (CCD) array or a complementary metal-oxide-semiconductor (CMOS) array. The CCD or CMOS array receives an image focused by the lens system 20 and generates an electronic imaging signal related to the amount of light received. The electronic image signal is provided to the processor P which processes the electronic image signal and stores corresponding image data in the memory M. It is also contemplated that the image sensor 14 may comprise a non-electronic image sensor such as analog film.

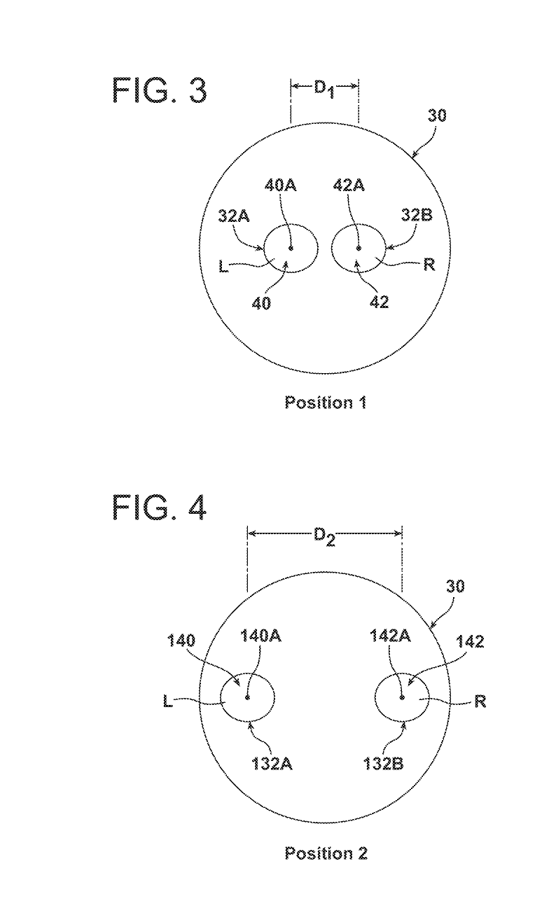

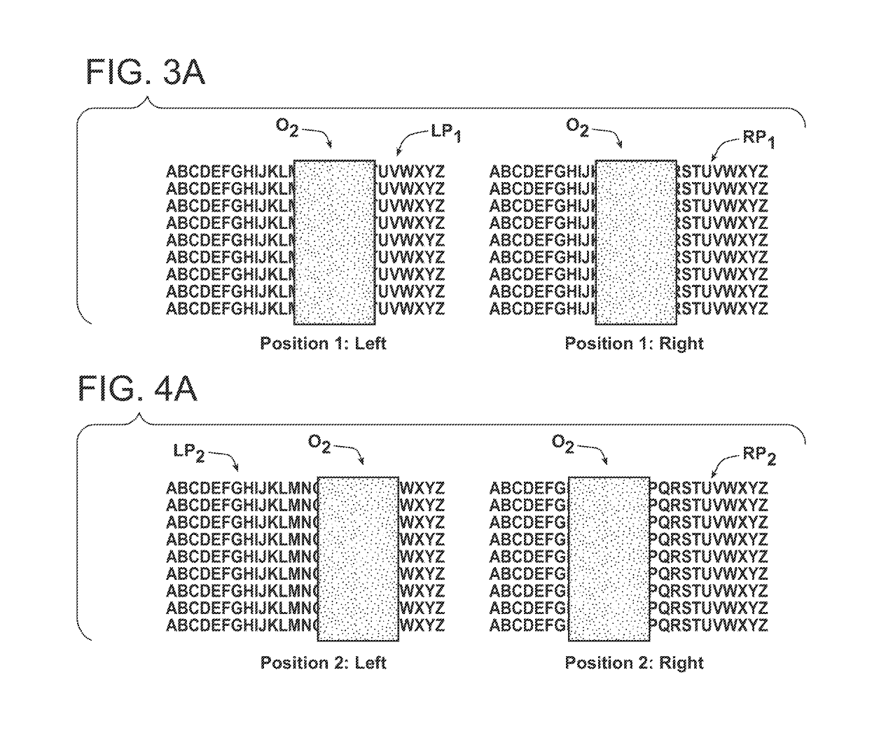

In accordance with the first aspect of the present invention, the processor P controls the matrix shutter 30 in accordance with a first exposure pattern stored in the memory M so as to actuate a first set 32A of shutter elements 32 for a first predefined time period to define a first or left pupil aperture 40 in the matrix shutter 30, and then a second set 32B of shutter elements 32 is actuated for a second predefined time period to define a second or right pupil aperture 42 in the matrix shutter 30, see FIG. 3. The first and second predefined time periods may be equal to one another in length but occur sequentially. When the first set 32A of shutter elements 32 is actuated, they become light transmissive so as to allow light to pass through the matrix shutter left pupil aperture 40 and the lens system 20 and impinge on the image sensor 14. When the first set 32A of shutter elements 32 is actuated, the second set 32B of shutter elements 32 is not actuated and, hence, those shutter elements are in an opaque state. When the second set 32B of shutter elements 32 is actuated, they become light transmissive so as to allow light to pass through the matrix shutter 30 and the lens system 20 and impinge on the image sensor 14. When the second set 32B of shutter elements 32 is actuated, the first set 32A of shutter elements 32 is not actuated and, hence, those shutter elements are in an opaque state.

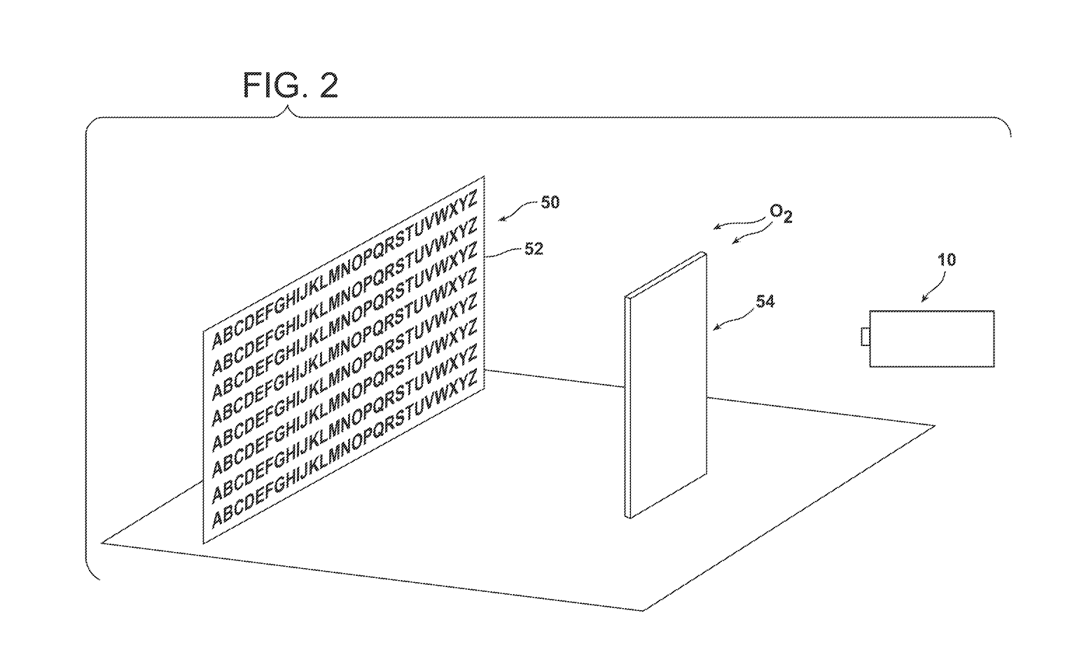

As shown in FIG. 3, a center point of the first pupil aperture 40 is horizontally spaced a first distance D₁ from a center point of the second pupil aperture 42. In an example illustrated in FIG. 2, the camera 10 is taking a still image or video, i.e., a plurality of images, of a scene O₂ comprising text 50 on a wall 52 and a door 54 positioned between the wall 52 and the camera 10. When the first pupil aperture 40 is light transmissive, a first left perspective image LP₁ of the scene O₂ is provided to the image sensor 14, see FIG. 3A. When the second pupil aperture 42 is light transmissive, a first right perspective image RP₁ of the scene O₂ is provided to the image sensor 14, see FIG. 3A.

For a still image, only a single first left perspective image LP₁ and a single first right perspective image RP₁ are recorded sequentially by the image sensor 14. When the image sensor 14 comprises an electronic image sensor, the processor P is coupled to the image sensor 14 and processes the corresponding electronic image signals from the image sensor 14 and stores corresponding image data in the memory M. The image data in memory M may be provided to a further processor (not shown), which functions to assist in the display of a 3-D still image of the scene O₂ on a display monitor. When the image sensor comprises film, the two frames can be scanned and digitally processed so as to be displayed as a 3-D still image by a display monitor.

For video imaging, alternating left perspective images LP₁ and right perspective images RP₁ are recorded by the image sensor 14. When the image sensor 14 comprises an electronic image sensor, the processor P is coupled to the image sensor 14 and processes the corresponding electronic image signals from the image sensor 14 and stores corresponding image data in the memory M. The image data in memory M may be provided to a further processor (not shown), which functions to display a 3-D video, i.e., a plurality of images, of the scene O₂ on a display monitor. When the image sensor comprises film, conventional shutter glasses may be used to view the displayed alternating left perspective images LP₁ and right perspective images RP₁.

If a user wishes to vary the 3-D depth of the door 54 relative to the text 50 on the wall 52, a different exposure pattern is used by the processor P so as to vary the spacing or distance between the centers of the left and right pupil apertures. For example, if a user wishes for the door 54 to appear further away from the text 50 on the wall 52, a second exposure pattern stored in memory M is used by the processor P so as to cause centers 140A and 140B of the left and right pupil apertures 140 and 142 to be horizontally spaced apart a second distance D₂, wherein the second distance D₂ is greater than the first distance D₁, please compare FIG. 4 with FIG. 3. More specifically, the processor P controls the matrix shutter 30 in accordance with the second exposure pattern stored in the memory M so as to actuate a third set 132A of shutter elements 32 for a first predefined time period to define a third or left pupil aperture 140 in the matrix shutter 30, and then a fourth set 132B of shutter elements 32 is actuated for a second predefined time period to define a fourth or right pupil aperture 142 in the matrix shutter 30, see FIG. 4. The first and second predefined time periods may be equal to one another in length but occur sequentially. When the third set 132A of shutter elements 32 is actuated, they become light transmissive so as to allow light to pass through the matrix shutter left pupil aperture 140 and the lens system 20 and impinge on the image sensor 14. When the third set 132A of shutter elements 32 is actuated, the fourth set 132B of shutter elements 32 is not actuated and, hence, those shutter elements are in an opaque state. When the fourth set 132B of shutter elements 32 is actuated, they become light transmissive so as to allow light to pass through the matrix shutter 30 and the lens system 20 and impinge on the image sensor 14. When the fourth set 132B of shutter elements 32 is actuated, the third set 132A of shutter elements 32 is not actuated and, hence, those shutter elements are in an opaque state.

When the third pupil aperture 140 is light transmissive, a second left perspective image LP₂ of the scene O₂ is provided to the image sensor 14, see FIG. 4A. When the fourth pupil aperture 142 is light transmissive, a second right perspective image RP₂ of the scene O₂ is provided to the image sensor 14, see FIG. 4A. As is apparent from a comparison of FIG. 4A with FIG. 3A, the door 54 appears further away from the text 50 on the wall 52 in the second left and right perspective images LP₂ and RP₂ of the scene O₂ as compared to the first left and right perspective images LP₁ and RP_{S} of the scene O₂.

For a still image, only a single second left perspective image LP₂ and a single second right perspective image RP₂ are recorded sequentially by the image sensor 14. When the image sensor 14 comprises an electronic image sensor, the processor P processes the corresponding electronic image signals from the image sensor 14 and stores corresponding image data in the memory M. The image data in memory M may be provided to a further processor (not shown), which functions to display a 3-D still image of the scene O₂ on a display monitor. When the image sensor 14 comprises film, the two frames can be scanned and digitally processed so that a 3-D still image may be displayed by a display monitor.

For video imaging, alternating second left perspective images LP₂ and second right perspective images RP₂ are recorded by the image sensor 14. When the image sensor 14 comprises an electronic image sensor, the processor P processes the corresponding electronic image signals from the image sensor 14 and stores corresponding image data in the memory M. The image data in memory M may be provided to a further processor (not shown), which functions to display a 3-D video, i.e., a plurality of images, of the scene O₂ on a display monitor. When the image sensor 14 comprises film, conventional shutter glasses may be used to view the displayed alternating second left perspective images LP₂ and second right perspective images RP₂.

If a user wishes for the door 54 to appear closer to the text 50 on the wall 52, an exposure pattern is used by the processor P so as to cause the left and right pupil apertures 140 and 142 to be located closer together. This action may cause the left and right pupil apertures 140 and 142 to be collocated or overlap so as to use some of the same shutter elements 32. This does not cause a problem as the apertures 140 and 142 are actuated sequentially allowing for overlapping operations of the common shutter elements 32.

In the embodiments illustrated in FIGS. 3 and 4, the first, second, third and fourth pupil apertures 40, 42, 140 and 142 are of substantially the same size, i.e., the same diameter. It is contemplated that the first and second pupil apertures 40, 42 may be sized differently, i.e., have different diameters, from the third and fourth pupil apertures 140 and 142 such that a first depth of field corresponding to the first exposure pattern differs from a second depth of field corresponding to the second exposure pattern.

If a user wishes to vary the depth of field of a 3-D image, a different exposure pattern is used by the processor P so as to vary the size of the left and right pupil apertures. As the size of the left and right pupil apertures increase, the depth of field decreases.

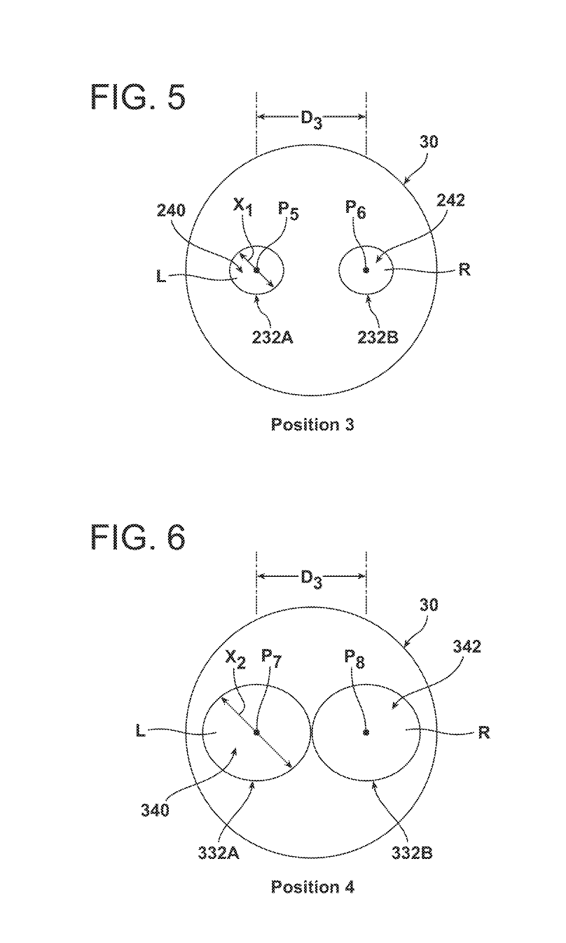

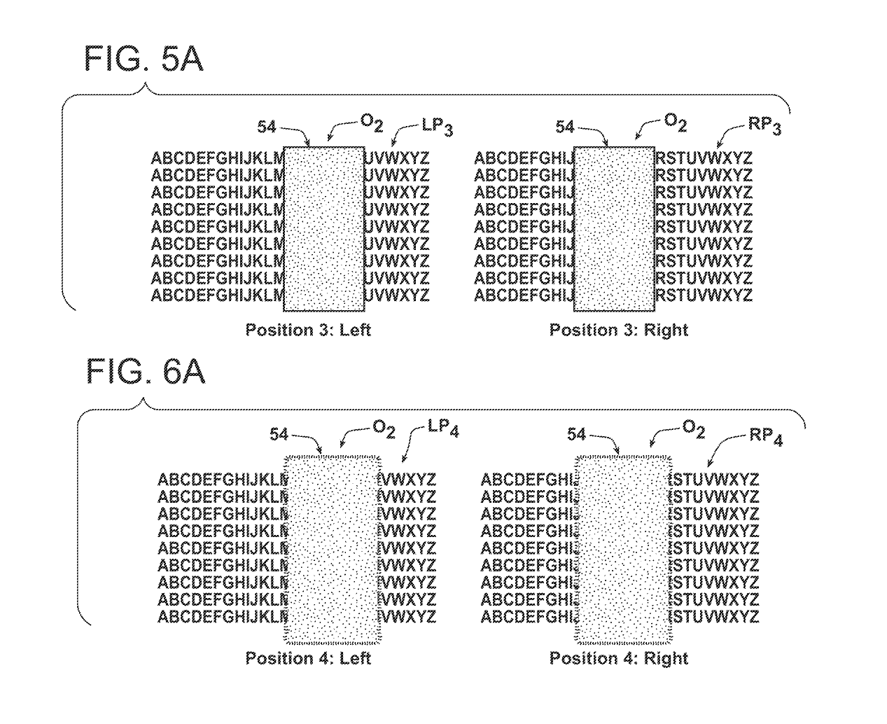

In FIG. 5, a third exposure pattern stored in memory M is used by the processor P so as to cause a fifth or left pupil aperture 240 and a sixth or right pupil aperture 242 to be defined. The left and right pupil apertures 240 and 242 have center points P₅ and P₆, respectively, spaced apart by a third distance D₃. More specifically, the processor P controls the matrix shutter 30 in accordance with the third exposure pattern stored in the memory M so as to actuate a fifth set 232A of shutter elements 32 for a first predefined time period to define the fifth or left pupil aperture 240 in the matrix shutter 30, and then a sixth set 232B of shutter elements 32 is actuated for a second predefined time period to define a sixth or right pupil aperture 242 in the matrix shutter 30, see FIG. 5. The first and second predefined time periods may be equal to one another in length but occur sequentially. When the fifth set 232A of shutter elements 32 is actuated, they become light transmissive so as to allow light to pass through the matrix shutter left pupil aperture 240 and the lens system 20 and impinge on the image sensor 14. When the fifth set 232A of shutter elements 32 is actuated, the sixth set 232B of shutter elements 32 is not actuated and, hence, those shutter elements are in an opaque state. When the sixth set 232B of shutter elements 32 is actuated, they become light transmissive so as to allow light to pass through the matrix shutter 30 and the lens system 20 and impinge on the image sensor 14. When the sixth set 232B of shutter elements 32 is actuated, the fifth set 232A of shutter elements 32 is not actuated and, hence, those shutter elements are in an opaque state.

When the fifth pupil aperture 240 is light transmissive, a third left perspective image LP₃ of the scene O₂ is provided to the image sensor 14, see FIG. 5A. When the sixth pupil aperture 242 is light transmissive, a third right perspective image RP₃ of the scene O₂ is provided to the image sensor 14, see FIG. 5A. The fifth and sixth pupil apertures 240 and 242 have a diameter equal to X₁, which is approximately equal to the diameters of the first, second, third and fourth pupil apertures 40, 42, 240, 242. Hence, the depth of field of the third left and right perspective images LP₃ and RP₃ of the scene O₂ is substantially equal to the depth of field of the first left and right perspective images LP₁ and RP_{S} and the second left and right perspective images LP₂ and RP₂of the scene O₂.

In FIG. 6, a fourth exposure pattern stored in memory M is used by the processor P so as to cause a seventh or left pupil aperture 340 and an eighth or right pupil aperture 342 to be defined. The left and right pupil apertures 340 and 342 have center points P₇ and P₈, respectively, spaced apart by a third distance D₃, which is substantially equal to the third distance D₃ in FIG. 5. More specifically, the processor P controls the matrix shutter 30 in accordance with the fourth exposure pattern stored in the memory M so as to actuate a seventh set 332A of shutter elements 32 for a first predefined time period to define the seventh or left pupil aperture 340 in the matrix shutter 30, and then an eighth set 332B of shutter elements 32 is actuated for a second predefined time period to define an eighth or right pupil aperture 342 in the matrix shutter 30, see FIG. 6. The first and second predefined time periods may be equal to one another in length but occur sequentially. When the seventh set 332A of shutter elements 32 is actuated, they become light transmissive so as to allow light to pass through the matrix shutter left pupil aperture 340 and the lens system 20 and be exposed on the image sensor 14. When the seventh set 332A of shutter elements 32 is actuated, the eighth set 332B of shutter elements 32 is not actuated and, hence, those shutter elements are in an opaque state. When the eighth set 332B of shutter elements 32 is actuated, they become light transmissive so as to allow light to pass through the matrix shutter 30 and the lens system 20 and be exposed on the image sensor 14. When the eighth set 332B of shutter elements 32 is actuated, the seventh set 332A of shutter elements 32 is not actuated and, hence, those shutter elements are in an opaque state.

When the seventh pupil aperture 340 is light transmissive, a fourth left perspective image LP₄ of the scene O₂ is provided to the image sensor 14, see FIG. 6A. When the eight pupil aperture 342 is light transmissive, a fourth right perspective image RP₄ of the scene O₂ is provided to the image sensor 14, see FIG. 6A. The seventh and eighth pupil apertures 340 and 342 have a diameter equal to X₂, which is greater in size than the diameter X₁ of the fifth and sixth pupil apertures 240 and 242. Hence, the depth of field for each of the fourth left and right perspective images LP₄ and RP₄ is less than the depth of field for each of the third left and right perspective images LP₃ and RP₃, i.e., the door 54 in each of the fourth left and right perspective images LP₄ and RP₄ is less clear, i.e., fuzzier, than the door 54 in each of the third left and right perspective images LP₃ and RP3, please compare FIG. 6A to FIG. 5A.

For a still image, only a single fourth left perspective image LP₄ and a single fourth right perspective image RP₄ are recorded sequentially by the image sensor 14. When the image sensor 14 comprises an electronic image sensor, the processor P processes the corresponding electronic image signals from the image sensor 14 and stores corresponding image data in the memory M. The image data in memory M may be provided to a further processor (not shown), which functions to display a 3-D still image of the scene O₂ on a display monitor. When the image sensor 14 comprises film the two frames can be scanned and digitally processed so as to be displayed by a display monitor. For video imaging, alternating fourth left perspective images LP₄ and fourth right perspective images RP₄ are recorded by the image sensor 14. When the image sensor 14 comprises an electronic image sensor, the processor P processes the corresponding electronic image signals from the image sensor 14 and stores corresponding image data in the memory M. The image data in memory M may be provided to a further processor (not shown), which functions to display a 3-D video, i.e. a plurality of images, of the scene O₂ on a display monitor. When the image sensor 14 comprises film, conventional shutter glasses may be used to view the displayed alternating fourth left perspective images LP₄ and fourth right perspective images RP₄.

The pupil apertures 40, 42, 140, 142, 240, 242, 340 and 342 are all shown in the illustrated embodiments as being circular. This is the most common mode of operation as it mimics the standard aperture stop found in circular lenses. Non-circular apertures may also be used in the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A stereoscopic camera comprising:
an image sensor;
a lens system adapted to focus light from a scene onto said image sensor, said lens system including an aperture stop;
an electronically actuatable matrix shutter including a plurality of individually addressable and actuatable shutter elements;
a memory; and
a processor communicating with said electronically actuatable matrix shutter and said memory, said processor controlling said matrix shutter to create pairs of pupil apertures according to a plurality of exposure patterns stored in said memory, said memory storing a first exposure pattern defining a first pair of first and second pupil apertures spaced apart from one another by a first distance and a second exposure pattern defining a second pair of third and fourth pupil apertures spaced apart from one another by a second distance which is different from said first distance.

2. The stereoscopic camera as set out in claim 1, wherein said first, second, third and fourth pupil apertures are of generally the same size.

3. The stereoscopic camera as set out in claim 1, wherein said first and second pupil apertures are sized differently from said third and fourth pupil apertures such that a first depth of field corresponding to said first exposure pattern differs from a second depth of field corresponding to said second exposure pattern.

4. The stereoscopic camera as set out in claim 1, wherein said first pupil aperture is defined by a first set of shutter elements that are light transmissive for a first predefined period of time and said second pupil aperture is defined by a second set of shutter elements that are light transmissive for a second predefined period of time.

5. The stereoscopic camera as set out in claim 4, wherein said first and second pupil apertures are sequentially formed by said matrix shutter.

6. The stereoscopic camera as set out in claim 4, wherein said matrix shutter comprises a liquid crystal shutter element comprising a two-dimensional array of individually addressable and actuatable shutter elements.

7. The stereoscopic camera as set out in claim 1, wherein matrix shutter is positioned generally at said aperture stop.

8. A stereoscopic camera comprising:
an image sensor;
a lens system adapted to focus light from a scene onto said image sensor, said lens system including an aperture stop;
an electronically actuatable matrix shutter including a plurality of individually addressable and actuatable shutter elements;
a memory; and
a processor communicating with said electronically actuatable matrix shutter and said memory, said processor controlling said matrix shutter to create pairs of pupil apertures according to a plurality of exposure patterns stored in said memory, said memory storing a first exposure pattern defining a first pair of first and second pupil apertures each of a first size and a second exposure pattern having a second pair of third and fourth pupil apertures each of a second size which is different from said first size such that a first depth of field corresponding to said first exposure pattern differs from a second depth of field corresponding to said second exposure pattern.

9. The stereoscopic camera as set out in claim 8, wherein center points of said first and second pupil apertures are separated from one another by a first distance and center points of said third and fourth pupil apertures are separated from one another by a second distance which is generally equal to said first distance.

10. The stereoscopic camera as set out in claim 8, wherein said first pupil aperture is defined by a first set of shutter elements that are light transmissive for a first predefined period of time and said second pupil aperture is defined by a second set of shutter elements that are light transmissive for a second predefined period of time.

11. The stereoscopic camera as set out in claim 10, wherein said first and second pupil apertures are sequentially formed by said matrix shutter.

12. The stereoscopic camera as set out in claim 8, wherein said matrix shutter comprises a liquid crystal shutter element comprising a two-dimensional array of individually addressable and actuatable shutter elements.

13. The stereoscopic camera as set out in claim 8, wherein matrix shutter is positioned generally at said aperture stop.
